(19) United States
(12) Patent Application Publication
(10) Pub. No.: US 2023/0154265 A1
(43) Pub. Date: May 18, 2023

(54) PERSONALIZATION METHOD FOR A MOTOR VEHICLE, AND A DATA RELEASE PROCEDURE FOR A BACKEND

(71) Applicant: Dr. Ing. h.c. F. Porsche Aktiengesellschaft, Stuttgart (DE)

(72) Inventor: Gaetano Marrone, Pforzheim (DE)

(73) Assignee: Dr. Ing. h.c. F. Porsche Aktiengesellschaft, Stuttgart (DE)

(21) Appl. No.: 17/985,228

(22) Filed: Nov. 11, 2022

(30) Foreign Application Priority Data
Nov. 12, 2021 (DE) 10 2021 129 489.4

(51) Int. Cl. G07C 9/32

(52) U.S. Cl. CPC G07C 9/32

(57) ABSTRACT

A personalization method for a motor vehicle and data release method. The motor vehicle includes at least the following components: an on-board computer; a human-machine interface; a vehicle-side data interface; and an access security device for recognizing physical or electronic vehicle-specific access authorization information. The personalization method includes a first step of recognizing, by the on-board computer using the access security device, the physical and/or electronic input of the vehicle-specific access authorization information. The method also includes a second step of retrieving and storing, by the on-board computer using the vehicle-side data interface, personal data of at least one user assigned to the motor vehicle. The second step is only carried out if in the first step the vehicle-specific access authorization information is recognized. The personalization method and data release method significantly simplify the personalization process in a motor vehicle.

### CROSS-REFERENCE TO RELATED APPLICATION

This application claims priority to German Patent Application No. 10 2021 129 489.4, filed Nov. 12, 2021, the content of such application being incorporated by reference herein in its entirety.

### FIELD OF THE INVENTION

The invention relates to a personalization method for a motor vehicle, to a data release method for a backend, and to a motor vehicle with such a data release method.

### BACKGROUND OF THE INVENTION

More and more demands are being placed on the market to connect a motor vehicle with its owners or users. Remote services, for example pre-climatizing the car by means of a mobile terminal or route planning on the home computer and transmitting the route to the motor vehicle, are highly requested functions. To this end, a clear link of the motor vehicle to the user is required so that the user can gain access to the remote services. Methods that initialize a link or personalization of the motor vehicle with the user are already known from the prior art.

Owing to the data protection requirements, upon first linking (personalization) of the vehicle to the user are very complex. Most often, a lengthy login process, which must usually be carried out within the motor vehicle, is needed before using the motor vehicle for the first time. Furthermore, the user is not recognized upon entering his/her motor vehicle for the first time but must first carry out the time-consuming and input-intensive personalization, even though all data are already known in advance and the purchased motor vehicle is known.

### SUMMARY OF THE INVENTION

Starting therefrom, it would be desirable to at least partially overcome the disadvantages known from the prior art. The features of the invention can be combined in any technically meaningful manner, wherein the explanations from the following description as well as features from the figures, which comprise supplementary embodiments of the invention, can also be used for this purpose.

The invention relates to a personalization method for a motor vehicle, wherein the motor vehicle comprises at least the following components:
an on-board computer;
a human-machine interface;
a vehicle-side data interface; and
an access security means for recognizing physical or electronic vehicle-specific access authorization information,

wherein the personalization method comprises at least the steps of:

a. recognizing, by the on-board computer by means of the access security means, the physical and/or electronic input of the vehicle-specific access authorization information; and

b. retrieving and storing, by the on-board computer by means of the vehicle-side data interface, personal data of at least one user assigned to the motor vehicle,

wherein step b. is only carried out if in step a., the vehicle-specific access authorization information is recognized.

Ordinal numbers used in the description above and below are used only for clear differentiation and do not reflect any order or ranking of the designated components, unless explicitly indicated otherwise. An ordinal number greater than one does not necessitate that a further such component must necessarily be present.

In order to carry out a personalization method for a motor vehicle, the motor vehicle comprises at least one on-board computer. The on-board computer comprises at least one processor and a memory unit, wherein the on-board computer is usually fixedly connected to the motor vehicle. The processor is configured to calculate data. The memory unit is configured to store and retrieve data. The on-board computer is thus configured to calculate various vehicle-related data and is also required as a component of the proposed personalization method in the motor vehicle. The memory unit in one embodiment alone comprises a short-term memory, for example a so-called working memory, and is connected to an external memory via a wireless connection. In another embodiment, the memory unit comprises a sufficiently large long-term memory, for example a so-called hard drive, and comprises all or at least the often needed or important data. In yet another embodiment, the memory unit comprises a small, long-term memory, in which only the required access data are stored, and is able by means of the access data to download the required data from an external memory via a wireless connection for everything else. Often, such external memories are provided by known internet service providers and/or the motor vehicle OEMs (OEMs, Original Equipment Manufacturer; in the field of motor vehicles, this refers to the customer-known brand manufacturers of motor vehicles). In one advantageous embodiment, the on-board computer is the computer used traditionally for many or all digital tasks of the motor vehicle. Alternatively, this is a separate on-board computer, i.e., a computer that is on board the motor vehicle.

Furthermore, the motor vehicle comprises a human-machine interface. In one embodiment, the human-machine interface comprises a display screen arranged in the vehicle interior, preferably a touch screen, and/or is configured for interaction with a user via a (e.g., multi-functional) keyboard instrument. The human-machine interface additionally or in an alternative embodiment comprises a mobile terminal (e.g., a smartphone) connected to the on-board computer by means of a wired or wireless connection. Nowadays, a mostly so-called infotainment system is executed on the on-board computer, wherein the human-machine interface (usually via a display screen) represents the user interface, sometimes (in the case of a touch screen) also forms the input interface.

The motor vehicle also comprises a vehicle-side data interface, which is configured to connect the on-board computer to a (e.g., mobile) network. By means of the vehicle-side data interface, retrieving data is enabled.

In order to unlock the motor vehicle, it is known that vehicle-specific access authorization information assigned to the motor vehicle, for example stored in an access authorization unit, such as a vehicle key, or as a biometric feature of the user (e.g., a fingerprint), is used. By means of the access authorization information, the user obtains an access authorization to the motor vehicle and/or its software, which enables access to the motor vehicle (e.g., the door opens) for the user and/or at least one authorized person. In one embodiment, the vehicle-specific access authorization information is stored on an access authorization unit, for example a (preferably radio) vehicle key, by means of which at least the driver door of the motor vehicle can be unlocked, for example, via an RFID chip [Radio-Frequency IDentification] by approaching and/or, for example, by radio and button press.

In an alternative embodiment, the vehicle-specific access authorization information is stored on a general access authorization unit, for example, a master key, which is provided by a vehicle manufacturer, for example, to a vehicle dealer in order to thus unlock a plurality of motor vehicles from a series and/or production. It should be noted that such master keys are only issued to authorized persons, for example vehicle dealers and are to be stored under strictly regulated conditions. For example, the master key is a key card having an RFID chip by means of which a plurality of motor vehicles can be unlocked. It should be noted that such a master key, at least from the perspective of the motor vehicle, contains access authorization information which is vehicle-specific at least to the extent that a close circle of users is ensured and the motor vehicle receives a signal that causes an unlocking. This signal is therefore not arbitrary.

In a further alternative embodiment, the vehicle-specific access authorization information is contained in an access authorization unit designed as a mobile terminal (e.g., a smartphone). By means of a smartphone, for example, which retrieves an additional physical security feature (e.g., a fingerprint or other biometric data) of the user, the motor vehicle can be unlocked. The mobile terminal is likewise configured to interact wirelessly with the motor vehicle.

For acquiring and recognizing the vehicle-specific access authorization information, the motor vehicle comprises an access security means communicatively connected to the on-board computer. The access security means is configured to acquire the vehicle-specific access authorization information, preferably only within a predetermined access area. The predetermined access area is a defined area in the vicinity of the motor vehicle. For example, the area is defined by the range of the access security means (e.g., designed as a radio antenna). Alternatively, the radio antenna is a directional antenna having a reception area which is defined at a physical or digital level and by means of which the access area is defined. For example, the vicinity is an area that extends one to two meters outward from the motor vehicle at at least one vehicle door. Preferably, reception also exists in the vehicle interior of the motor vehicle (e.g., via a further antenna and/or a slot) so that the presence of the access authorization unit (containing the vehicle-specific access authorization information) is ensured even when this access authorization unit is located in the interior of the motor vehicle. In this embodiment, the predetermined access area extends into the vehicle interior. Alternatively, entry (e.g., a button press on the radio key) and exit (e.g., a repeated press or a press on another button) is monitored so that the access authorization unit with the vehicle-specific access authorization information is considered to be present in the predetermined access area when an entry and no exit has occurred.

It should be noted that it is sufficient in one embodiment when the access authorization information has been recognized once. For example, this is a meaningful application for a showroom where vehicles are parked open and (possibly to a limited extent) operational. Unauthorized access to a motor vehicle is sufficiently secured by the secured environment of the showroom. Presence of an access authorization unit is thus not necessary.

In one embodiment, the access security means is at least one of the door locks of a vehicle door of the motor vehicle. The access authorization unit is then a vehicle key and the access authorization information is in the form of the key bit, wherein further electronic security features may form part of the access authorization information.

In step a. of the personalization method, the on-board computer acquires and recognizes the vehicle-specific access authorization information by means of the access security means (e.g., within the predetermined access area). For example, the user of the motor vehicle moves into the predetermined access area so that the vehicle-specific access authorization unit (or the access authorization information stored therein and transmitted) is recognized by the on-board computer by means of the radio antenna. The on-board computer compares the vehicle-specific access authorization information with the access authorization already stored. If it is correct, the next step of the personalization method is carried out.

If the vehicle-specific access authorization information has been acquired by the on-board computer, personal data of at least one user (preferably the main user) assigned to the motor vehicle, or one portion of the personal data of at least one user, are retrieved by the on-board computer by means of the vehicle-side data interface and stored in step b. Preferably, the motor vehicle is also unlocked (in, for example, a previously known manner). The personal data inter alia include the names of the users and the menu language of the infotainment system, for example.

In one embodiment, the assigned personal data of the user has been acquired in a step preceding the personalization method. For example, at the conclusion of purchase of the motor vehicle and/or during registration within a manufacturer's application, preferably for a mobile terminal, which can also particularly preferably be used as a vehicle-specific access authorization unit (i.e., for storing and transmitting the access authorization information).

In an alternative embodiment, the personal data have already been stored in a backend and have been biuniquely assigned to the motor vehicle in a previous step (cf. in this respect the description below) so that these data or at least one portion of the personal data are retrieved and stored in step b. For example, the personal data have already been acquired and stored during a previous purchase of a motor vehicle.

In one embodiment, the vehicle-specific access authorization information is also individually assigned to one of a plurality of users. Then, only that part of the data assigned to that user, e.g., the name, is preferably displayed in step b. In a preferred embodiment, all data required or approved by one or all users are retrieved and stored by the on-board computer, but only the data of the user (preferably necessarily present) according to the recognized vehicle-specific (and user-specific) access authorization information are displayed.

In one advantageous embodiment, a start of the journey (at least a regular one, for example without location restriction and/or mileage restriction as in a demonstration operation) with the motor vehicle is only possible if the personalization method has been successfully completed or at least started, preferably a predetermined first part has been completed. It should be noted that in this personalization method, at least those data that are necessary (e.g., according to legal or company regulations) for starting a journey are then accessed and stored, preferably also such data that are necessary for an individual use profile, for example an adjustment of the driver's seat or of all seats in the motor vehicle.

It should be noted that the motor vehicle or its on-board computer is the only external entity that is able to readily access the associated data (i.e., without a password, for example). There are various unchangeable security features that make it possible that the motor vehicle requesting that data can be biuniquely identified. Thus, only the motor vehicle has access to the data space. For example, the user cannot access the data or can only access the data with limited writing permissions. For example, an authorized person may only enter the data once and no longer change them (without further authorization of the user). For example, the company providing this service, such as the OEM or an external service provider of the OEM, may, for example, only change the vehicle-side data and, where applicable, overlapping data. For example, a different vehicle than originally planned (e.g., due to supply shortages, a change of decision, or other reasons) may be allocated by the company to the user at short notice. If this is not the vehicle that wants to access the data, an access request (preferably a highly secure one) takes place beforehand, for example input of an email address and a random 256-bit key (e.g., with more than 20 characters).

It is furthermore proposed in an advantageous embodiment of the personalization method that step b. continues to be carried out only if a one-time access has also been entered via the human-machine interface of the motor vehicle in a step c.

In order for the retrieval and storing of personal data, assigned to the motor vehicle, of at least one user to be initialized in step b. of the personalization method, a conditional additional step c. is proposed here, wherein step c. is carried out before step b. in the personalization method. Step a. is thus not a sufficient condition in this embodiment of the personalization method. However, step a. and step c. together are preferably a sufficient condition for carrying out step b.

In step c., a one-time access is entered via the human-machine interface. For example, the one-time access is a user name and password, wherein the user name and password are shorter and easier to implement than a one-time access from conventional personalization methods. For example, a user name is the first name or last name of the user or a fancy name of a similar length and preferably easy to remember for a person. The password is preferably a PIN [Personal Identification Number] with 3 to 6 digits, preferably numbers only. This combination as a one-time access is sufficiently secure for the process and easy to remember or at least to type in (i.e., with little chance of typing errors), especially for an authorized person, such as a dealer. Due to the additional security, this simplification of the one-time access can be carried out by recognizing the vehicle-specific access authorization information.

So far, for example, the email address along with a 128- or 256-bit code have been necessary, both of which are highly susceptible to typing errors and are usually difficult to remember, especially for a third party such as the dealer. So far, this has been standard because the additional security feature of the vehicle-specific access authorization information (e.g., the vehicle key, preferably present in the access area of the motor vehicle) has not been taken into account.

It is furthermore proposed in an advantageous embodiment of the personalization method that the one-time access is entered in step c.:
by an authorized person; or
by means of the on-board computer, wherein the on-board computer receives the one-time access by means of the vehicle-side data interface only if the vehicle-specific access authorization information is recognized in step a.

Here, it is proposed in one embodiment that the one-time access is entered by an authorized person in step c. In this embodiment, the input takes place manually by means of the human-machine interface within the motor vehicle. The authorized person is, for example, a vehicle dealer who prepares the motor vehicle for handover to the user. For this purpose, the one-time access was transmitted to the authorized person to prepare the motor vehicle for the user by means of the vehicle-specific access authorization information (e.g., with an RFID key as the access authorization unit in the pocket or on the clipboard) and the one-time access.

In an alternative embodiment, the one-time access is entered by means of the on-board computer in step c. of the personalization method. In this embodiment, the one-time access has been transmitted to the on-board computer by means of the vehicle-side data interface if the vehicle-specific access authorization information was previously recognized in step a. This method resembles the following variant or is identical thereto in terms of security. The difference is that this variant is compatible with a conventional data structure in comparison to the variant mentioned below; because such a one-time access is currently a necessary condition in a conventional data structure. The security is sufficient according to the above explanations. This embodiment of the personalization method can thus be implemented in motor vehicles already on the market (e.g., used cars) and in (new) motor vehicles with conventional hardware or software architecture.

It should be noted that in a strict data protection environment, such as the scope of application of GDPR or comparable laws, the user has decidedly given his/her consent to the personalization method proposed herein for both embodiments. For example, during the conclusion of purchase of the motor vehicle, in addition to the personal data, consent for the personalization method has additionally been requested by a vehicle dealer or a computer program.

It is furthermore proposed in an advantageous embodiment of the personalization method that recognizing the vehicle-specific access authorization information in step a. is a sufficient condition for carrying out step b.

By means of the possibly necessary, explicit consent of the user to the personalization method, a sufficient condition for carrying out step b. results after the vehicle-specific access authorization information has been acquired and recognized in step a. It should be noted that no further input is necessary. The presence of the access authorization unit with the vehicle-specific access authorization information (at least once, preferably the presence continuing while this method is being carried out) is alone sufficient. This requires appropriate communication with the network, for example a backend of the OEM or their service provider, as well as an input interface on the on-board computer capable of exchanging code with the network.

In one embodiment, the vehicle-specific access authorization information is also user-specific. Then, in an advantageous embodiment, only data associated with the user or, based on (previous) consent of the other users, also their data are transferred.

It should be noted that step b. does not necessarily equate to an access authorization of the user. Rather, the data are only stored in the on-board computer of the motor vehicle and are provided for access from then on independently of an external data connection (e.g., to a backend or to a mobile terminal of the user). However, the access itself is secured in one embodiment by means of a user-specific input (cf. in this respect below). Nevertheless, in one embodiment, it is possible for one or all users (e.g., in advance) to waive such access protection.

It is furthermore proposed in an advantageous embodiment of the personalization method that the personal data of the at least one user of the motor vehicle comprise a user-specific security feature, wherein only upon input of the user-specific security feature into the human-machine interface and/or into an access authorization unit, which contains the vehicle-specific access authorization information, at least one of the following privileges is activated:
access to predetermined user information;
a predetermined function of the motor vehicle; and
release for external access to the motor vehicle and/or at least one portion of the user information.

The personal data retrieved and stored in step b. additionally comprise a user-specific security feature. For example, the user-specific security feature is a PIN (i.e., a predetermined sequence of digits and/or numbers), a fingerprint of the user (e.g., stored in a smartphone or at the conclusion of purchase), and/or another biometric feature (e.g., a face shape and/or iris pattern).

The user-specific security feature is designed in such a way that predetermined privileges are only activated for at least one user of the motor vehicle. In order to unlock the privileges, the user enters the user-specific security feature into the human-machine interface or an access authorization unit (e.g., designed as a mobile terminal), which contains the vehicle-specific access authorization information. In one embodiment, the presence of a mobile terminal (e.g., by means of a PAN [Personal Area Network]) is sufficient input, wherein the access authorization information is automatically transmitted from the mobile terminal to the on-board computer of the motor vehicle, which is, for example, triggered by unlocking at least one of the vehicle doors, for example, by means of the mobile terminal of the user.

For example, after recognizing the vehicle-specific access authorization information in step b., the personal data of the user are retrieved and stored, which does not cause any privileges to be activated. The privileges are activated only if the user has entered the user-specific security feature.

In one embodiment, the privileges include access to predetermined user information (e.g., telephone numbers, contact details, navigation destinations, and/or payment information), which thus only becomes visible after the user-specific security feature has been entered, or is only retrieved and stored after the user-specific security feature has been entered. The retrieval and storing on the on-board computers takes place from a backend, which functions as a memory device for the user information. Alternatively or additionally, a wireless connection to the or another backend, or a sub-entity, is only activated by the input of the user-specific security feature so that a retrieval of the user information can only then be carried out.

In another embodiment, the privileges comprise at least one predetermined function of the motor vehicle. For example, in an advantageous embodiment, moving the motor vehicle is only enabled after activation so that it is ruled out that a person other than the user can drive away with the motor vehicle. Alternatively or additionally, release takes place via a predetermined traction battery capacity so that an additional range is activated in a battery-electric motor vehicle. The motor vehicle can be moved and thus presented by a dealer (authorized person) in a very restricted radius of motion.

In an alternative embodiment, after the input of the user-specific security feature, release for external access to the motor vehicle and/or to at least one portion of the user information takes place. With the release, pre-climatizing by means of a mobile terminal is, for example, enabled or access to predetermined contact details stored on the on-board computer.

It should be noted that all embodiments can be carried out after input of the user-specific security feature, and/or a combination of portions of a respective embodiment can be carried out.

According to another aspect, a data release method for a backend is proposed, wherein the backend comprises at least the following components:
at least one processor;
a memory device; and
a backend-side data interface, wherein the data release method comprises at least the steps of:

i. maintaining, by means of the memory device, a register of personal data of a plurality of users and of a plurality of motor vehicle identities;

ii. assigning, by means of the processor, personal data from step i. to a respective motor vehicle identity;

iii. transmitting, by means of the backend-side data interface upon a retrieval by a motor vehicle with a motor vehicle identity, at least one portion of the associated personal data to the retrieving motor vehicle.

The data release method proposed here can be carried out on a backend, wherein the backend is, for example, a server setup or a plurality of servers communicatively connected to one another. The backend comprises at least one processor, wherein the processor is configured to calculate or assign data. Furthermore, the backend comprises a memory device, wherein the memory device is configured to store or provide data. The memory device is communicatively connected to the processor so that data on the memory device can be calculated and/or assigned by means of the processor. Functionally, the memory unit of the on-board computer and the memory device of the backend are the same as are their processors. For example, both may be referred to as computers that can be configured for their respective task at the software level without any fundamental differences in hardware.

In addition, a backend-side data interface is comprised by the backend so that the backend-side data interface is configured to communicate data and is communicatively connected to the processor and the memory device. In one embodiment, during step iii. and step b., the backend-side data interface is communicatively connected to a vehicle-side data interface.

In step i. of the data release method, personal data of a plurality of users and a plurality of motor vehicle identities are stored or provided, i.e., maintained in a register, by means of the memory device. The register may be created in advance and/or is subject to ongoing editing or can be edited permanently. The personal data have been collected from a plurality of users and from a plurality of motor vehicle identities in a previous step or have already been known and/or stored from previous and/or conventional data release methods, for example, upon completion of purchase of the motor vehicle or upon registration within a manufacturer application for a mobile terminal. The personal data inter alia include the names of the users, and preferably the telephone contacts, payment details and the menu language of the infotainment system. The motor vehicle identity comprises, for example, the biuniquely assignable vehicle identification number, and preferably the color of the motor vehicle and the (possibly special) equipment.

Subsequently to at step i. of the data release method, the personal data from step i. are assigned in step ii. to a respective motor vehicle identity by means of the processor. For example, the already existing or newly stored personal data from step i. are linked to the newly purchased motor vehicle in such a way that when the personal data are retrieved, the motor vehicle identity can be biuniquely assigned.

In step iii. of the data release method, at least one portion of the personal data is transmitted to a motor vehicle by means of a backend-side data interface, wherein the transmission takes place only if the motor vehicle with the motor vehicle identity assigned to the personal data retrieves the personal data. In one embodiment, the personal data transmitted by means of the backend-side data interface in step b. of the personalization method described above are received by means of the vehicle-side data interface.

The data release method is configured in such a way that at least one portion of the data is transmitted only if the motor vehicle identity of the motor vehicle matches the associated personal data. Transmission of the personal data to another motor vehicle that is not assigned to the personal data is thus excluded.

In a preferred embodiment, the personalization method and the data release method are adapted to one another in such a way that retrieval and transmission are carried out without or with only a slight propagation delay (without consideration of any transmission disruptions in the communication network). For example, the backend-side data interface and the vehicle-side data interface are adapted to the retrieval and transmission so that the personal data, or at least one portion of the personal data, are already transmitted in a data format that can be processed in the on-board computer of the motor vehicle without conversion.

It should be noted that the data interfaces preferably utilize the conventional, more preferably wireless, communication networks, such as satellite-based communications or cellular communications (e.g., 3G or newer, preferably LTE or 5G). Alternatively or additionally, a local area network, such as W-LAN [Wireless Local Area Network], or another network is utilized.

It is furthermore proposed in an advantageous embodiment of the data release method that step iii. is carried out only if a one-time access has been transmitted via the backend-side data interface to the backend in a step iv.

In order for the transmission of the personal data, retrieved by the motor vehicle, of at least one user to be initialized in step iii. of the data release method, a conditional additional step iv. is proposed here, wherein step iv. is arranged before step iii. of the data release method. In step iv., a one-time access is transmitted via the backend-side data interface. The condition in step iii. is thus not a sufficient condition in this embodiment of the data release method.

In one embodiment, the one-time access has been entered via the human-machine interface in a motor vehicle so that said one-time access has been transmitted via the backend-side data interface to the backend in step iv. If the one-time access has been stored and verified in the backend, step iii. of the data release method is carried out so that at least one portion of the personal data is transmitted to the motor vehicle.

In an alternative embodiment, the one-time access has been entered by means of the on-board computer so that said one-time access has been transmitted by means of the backend-side data interface to the backend in step iv. The subsequent step iii. of the data release method can thus be carried out.

For the description of the vehicle-side processes, reference is made purely by way of example to the above explanations regarding the personalization method.

It is furthermore proposed in an advantageous embodiment of the data release method that the presence of the motor vehicle identity and/or the presence of physical and/or electronic vehicle-specific access authorization information is a sufficient condition for carrying out step iii.

According to this embodiment, the data release method is carried out in such a way that a sufficient condition for carrying out step iii. is that the motor vehicle identity is present in the backend or vehicle-specific access authorization information of a vehicle-specific access authorization unit has been recognized in step iv. The vehicle-specific access authorization information or the confirmation that said information has been recognized (and is possibly present during the process) is transmitted by means of the vehicle-side data interface to the backend upon retrieval of the at least one portion of the personal data. Due to the biunique assignment of the personal data to the motor vehicle identity, an incorrect transmission of the personal data, for example to another motor vehicle or to another entity, is excluded.

In an alternative embodiment, in step iv., the vehicle-specific access authorization information is transmitted to the backend and only recognized there. Alternatively, the vehicle-specific access authorization information has been indirectly recognized in that the vehicle is configured to be able to communicate only if the vehicle-specific access authorization information has been recognized by the on-board computer of the motor vehicle (and is possibly present during the process). In this embodiment of the data release method, this constitutes a sufficient condition for carrying out step iii. In this embodiment, the vehicle-specific access authorization information is biuniquely assigned to the vehicle to be considered, so that due to the recognition of the vehicle-specific access authorization information, incorrect transmission of the personal data, for example to another vehicle, is excluded.

It is furthermore proposed in an advantageous embodiment of the data release method that the personal data of the at least one user of the motor vehicle comprise a user-specific security feature, wherein only upon transmission of the user-specific security feature, at least one of the following privileges is transmitted or release for access to at least one of the following privileges is transmitted:
access to predetermined user information;
a predetermined function of the motor vehicle; and
release for external access to the motor vehicle and/or at least one portion of the user information.

The personal data of the at least one user transmitted in step iii. additionally comprises a user-specific security feature. For example, the user-specific security feature is a PIN (i.e., a predetermined sequence of digits and/or numbers), a fingerprint of the user (e.g., stored in a smartphone or at the conclusion of purchase), and/or another biometric feature (e.g., a face shape and/or iris pattern).

The user-specific security feature is designed in such a way that predetermined privileges are only activated for at least one user of the motor vehicle. In order to activate the privileges, the user-specific security feature or the confirmation that the user-specific security feature is present or has been entered must be transmitted to the backend. The user must enter the user-specific security feature into the human-machine interface or an access authorization unit (e.g., designed as a mobile terminal), which contains the vehicle-specific access authorization information. Then, by means of the backend-side data interface, an activation and/or retrieval of the privileges to the motor vehicle is initialized.

In one embodiment, the privileges include access to predetermined user information (e.g., telephone numbers, contact details, and/or payment information), which are thus only released for retrieval after the user-specific security feature has been entered. Alternatively or additionally, a wireless connection to the backend, or a sub-entity, is only activated by the input of the user-specific security feature so that a retrieval of the user information can only then be carried out.

In another embodiment, the privileges comprise at least one predetermined function of the motor vehicle. For example, in an advantageous embodiment, moving the motor vehicle is only enabled after activation so that it is ruled out that a person other than the user can drive away with the motor vehicle. Alternatively or additionally, release takes place via a predetermined traction battery capacity so that an additional range is activated in a battery-electric motor vehicle. The motor vehicle can be moved and thus presented by a dealer (authorized person) in a very restricted radius of motion. In this embodiment, this is set via a required (operational) release of the backend.

In an alternative embodiment, after the input of the user-specific security feature, release for external access to the motor vehicle and/or to at least one portion of the user information takes place by means of the backend. With the release, pre-climatizing by means of a mobile terminal is, for example, enabled or access to predetermined contact details stored on the on-board computer.

It should be noted that all embodiments can be carried out after input of the user-specific security feature, and/or a combination of portions of a respective embodiment can be carried out.

According to a further aspect, a motor vehicle is proposed, comprising at least one drive wheel, at least one drive unit for driving the motor vehicle via the at least one drive wheel, as well as an on-board computer, a human-machine interface, a vehicle-side data interface and an access security means, wherein the personalization method according to one embodiment according to the above description can be carried out by means of the motor vehicle, preferably in communication with a backend, on which the data release method according to one embodiment according to the above description can be carried out.

The motor vehicle comprises an electrical or electrified powertrain, which is, for example, conventionally designed or alternatively can at least be conventionally operated. By means of the at least one drive wheel (e.g., two wheels of a common wheel axis, preferably of two wheel axes, for example as all-wheel drive), the motor vehicle can be moved, wherein the at least one drive wheel is comprised by a drive unit.

Furthermore, the motor vehicle comprises an on-board computer. For this purpose, the on-board computer is designed as a (conditional and at least therefore) central control unit and is communicatively connected to a human-machine interface. The human-machine interface is configured for the interaction of a user of the motor vehicle with the motor vehicle. The on-board computer is communicatively connected to a vehicle-side data interface and an access security means. The vehicle-side data interface is configured for communication with a backend. The access security means is configured to recognize vehicle-specific access authorization information (preferably only in a predetermined access area). For example, the access security means is a door lock or a door locking system, preferably comprising a corresponding security electronics and/or a radio antenna for detecting a radio signal within an access area of a (vehicle-specific) radio key.

The motor vehicle is designed to be configured to carry out the personalization method according to the above description. In a preferred embodiment, the motor vehicle is configured to communicate by means of the vehicle-side data interface and the backend, wherein the backend is configured to carry out the data release method according to the above description.

Reference is made to the above description regarding the personalization method and/or the data release method to the extent that the motor vehicle and the interaction with the method or methods are explained therein.

According to a further aspect, a computer program is proposed, comprising computer program code, wherein the computer program code can be executed on at least one computer in such a way that the at least one computer is caused to carry out one of the methods according to one embodiment according to the above description, wherein at least one unit of the computer:
is arranged in the motor vehicle, preferably as an on-board computer; and/or
is configured to communicate with a cloud or backend, which preferably provides at least one portion of the computer program code.

The method described herein is carried out in a computer-implemented manner according to this embodiment. The computer-implemented method is stored as computer program code, wherein the computer program code, when executed on a computer, causes the computer to carry out the method according to one embodiment according to the above description.

For example, the computer-implemented method is realized by a computer program, wherein the computer program comprises the computer program code, wherein when executed on a computer, the computer program code causes the computer to carry out the method according to one embodiment according to the above description. The term “computer program code” refers to one or more instructions or commands, which cause a computer or a processor to perform a number of operations, which constitute an algorithm and/or other processing methods, for example.

Preferably, the computer program can be partially or entirely executed on a server or server unit of a cloud system, a handheld device (e.g., a smartphone), and/or on at least one unit of the computer. The term “server” or “server unit” refers herein to such a computer that provides data and/or operational services or services for one or more other computer-aided devices or computers, thus forming the cloud system. The at least one unit of the computer in the motor vehicle (e.g., as the on-board computer) is, for example, conventionally designed and comprises a memory unit and a processor. Alternatively, the at least one unit of the computer is configured to communicate with a motor vehicle, for example as part of a server and/or a cloud, wherein the server and/or the cloud is arranged, for example, on site at a manufacturer of the computer.

The terms “cloud system” and “computer” are used herein with the same meaning as the devices known from the prior art. Accordingly, a computer comprises one or more general-purpose processors (CPU) or microprocessors, RISC processors, GPU, and/or DSP. For example, the computer comprises additional elements such as memory interfaces or communication interfaces. Optionally or additionally, the terms refer to such a device that is capable of executing a provided or integrated program, preferably with standardized programming language (e.g., C++, JavaScript, or Python), and/or controlling and/or accessing data memory devices and/or other devices, such as input interfaces and output interfaces. The term “computer” also refers to a plurality of processors or a plurality of (sub)computers that are interconnected and/or connected and/or otherwise communicatively connected and possibly jointly use one or more other resources, such as a memory. A (data) memory is, for example, a hard drive (HDD) or a (non-volatile) solid-state memory, for example a ROM memory or flash memory [Flash EEPROM]. The memory often comprises a plurality of separate physical units or is distributed to a plurality of separate devices so that access thereto takes place via data communication, for example package data service. The latter is a decentralized solution, wherein memories and processors of a plurality of separate computers are used instead of a (single) central server or in addition to a central server.

According to a further aspect, a computer program product is proposed, on which a computer program code is stored, wherein the computer program code can be executed on at least one computer in such a way that the at least one computer is caused to carry out at least one of the methods according to one embodiment according to the above description, wherein at least one unit of the computer:
is arranged in the motor vehicle, preferably as an on-board computer; and/or
is configured to communicate with a cloud or backend, which preferably provides at least one portion of the computer program code.

As a computer program product comprising the computer program code described above, is, for example, a medium, such as RAM, ROM, SD card, memory card, flash memory card or disk, or can be stored on a server and downloaded. Once the computer program is rendered readable via a readout unit, for example a drive, and/or installation, the computer program code and the method contained therein can be executed by a computer or in communication with a plurality of server units, for example according to the above description.

According to a further aspect, a personalization system is proposed comprising a motor vehicle according to one embodiment according to the above description and a backend according to one embodiment according to the above description, which are configured to carry out the personalization method according to one embodiment according to the above description and the data release method according to one embodiment according to the above description in interaction with one another.

Finally, it should be noted that in one variant in which the user himself/herself carries out the personalization, the process is carried out quickly and possibly without any attention given to it (in the case of autonomous execution by the on-board computer) so that the motor vehicle is quickly fully operational and can preferably welcome the user (at least sensed) directly personally (e.g., by name) after the startup. In a variant in which the user leaves the personalization to an authorized person, the process can be easily and quickly carried out by the authorized person. The user can then take over the personalized, directly operational motor vehicle.

### BRIEF DESCRIPTION OF THE DRAWINGS

The invention described above is explained in detail below with reference to the accompanying drawings, which show preferred embodiments, in light of the relevant technical background. The invention is not limited in any way by the purely schematic drawings, wherein it is noted that the drawings are not true to size and are not suitable for defining proportions. Shown are:

FIG. 1: a motor vehicle with an on-board computer; and

FIG. 2: a sequence diagram of a data release method and of a personalization method.

### DETAILED DESCRIPTION OF THE INVENTION

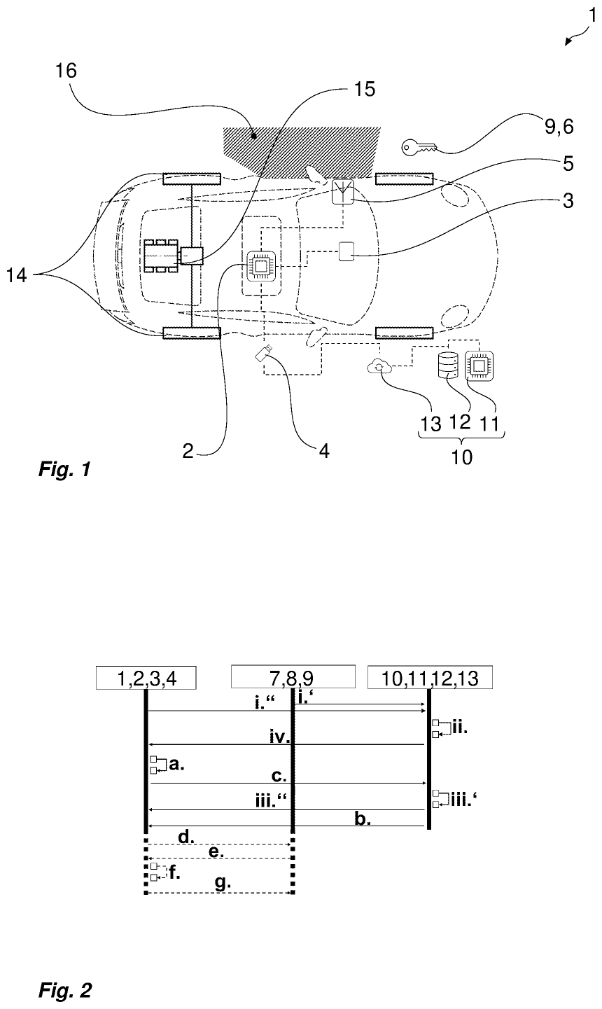

FIG. 1 shows a motor vehicle 1 with an on-board computer 2 in a schematic plan view. In addition to the on-board computer 2, the motor vehicle 1 comprises a drive unit 15, designed in this embodiment as an internal combustion engine, wherein the drive unit 15 is connected in a torque-transmitting manner to at least one drive wheel 14 (here, for example, two drive wheels 14). Furthermore, the motor vehicle 1 comprises a human-machine interface 3, which is configured to interact with a person or an authorized person 8. Here, an access security means 5 is designed as a locking system with a radio antenna, wherein the radio antenna (or the associated locking system) is communicatively connected to the on-board computer 2 and is comprised by the motor vehicle 1. The radio antenna defines, with its range and/or orientation, a predetermined access area 16 (hatched here). Within the access area 16, the radio antenna is configured to recognize vehicle-specific access authorization information 6, which here by means of a (radio-enabled) access authorization unit 9, here outlined as a vehicle key. The recognition of the vehicle-specific access authorization information 6 is transmitted by means of a vehicle-side data interface 4 to a backend-side data interface 13 (configured for transmission). The vehicle-side data interface 4 is comprised by the motor vehicle 1, wherein the backend-side data interface 13 is comprised by a backend 10. In this example, the vehicle-side data interface 4 is shown as a USB stick for wired data transmission to the backend 10 for clarity. Preferably, the transmission is wireless via an antenna positioned on the exterior of the vehicle.

In addition to the backend-side data interface 13, the backend 10 comprises a memory device 12 and a processor 11, wherein the backend 10 is configured to carry out a data release method and the on-board computer 2 is configured to carry out a personalization method, as shown in FIG. 2, for example.

FIG. 2 shows a sequence diagram of a data release method and a personalization method, as they can be carried out on an on-board computer 2 or backend 10 according to FIG. 1 in their communications. In the following description, reference is made to the motor vehicle 1 and the backend 10 according to FIG. 1, and in this respect, reference is made to the description therein.

In step i. (of the data release method), personal data of a plurality of users 7 and a plurality of motor vehicle identities are stored or provided by means of the memory device 12. The respective motor vehicle identity of a plurality of motor vehicles 1 are already stored (separately from the user data in a sub-step i.′), for example in the course of final acceptance in production and/or delivery to a dealer or user. The motor vehicle identity comprises, for example, the biuniquely assignable vehicle identification number, the color of the motor vehicle 1 and any special equipment. The personal data have been collected (in a sub-step i.″) from a plurality of users 7 in a previous step or have already been known and/or stored from previous and/or conventional data release methods, for example at the conclusion of purchase of the motor vehicle 1 or upon registration within a manufacturer application for a mobile terminal. The personal data inter alia include, for example, the names of the users 7, the telephone contacts, payment details and the menu language of the infotainment system.

Subsequently to step i. of the data release method, the personal data from step i. are assigned to a respective motor vehicle identity in step ii. by means of a processor 11. For example, the already existing or newly stored personal data of the user from step i. are linked to the newly purchased motor vehicle 1 in such a way that when the personal data are retrieved, the motor vehicle identity can be biuniquely assigned.

In step a. (of the personalization method), the on-board computer 2 recognizes the vehicle-specific access authorization information 6 by means of the access security means 5 (e.g., comprising a radio antenna) in the predetermined access area 16. For example, (in this example), the authorized person 8 (alternatively the user 7) of the motor vehicle 1 moves into the predetermined access area 16 so that the vehicle-specific access authorization information 6 is transmitted by means of the radio antenna of the access security means 5 to the on-board computer 2 and recognized there, and it may also be necessary to press a button (e.g., to open at least one of the vehicle doors). The on-board computer 2 then compares the vehicle-specific access authorization information 6 to the access authorization already stored. If it is correct, the next step of the personalization method is carried out.

According to an optional embodiment, in step iv., a one-time access is transmitted to an authorized person 8 (alternatively the user 7) via the backend-side data interface 13. In the exemplary embodiment shown, in step iv., the one-time access to the on-board computer 2 of the motor vehicle 1 is entered via the human-machine interface 3 in a motor vehicle 1 by the authorized person 8 (in step c.) so that this one-time access has been transmitted to the backend 10 in step iv. via the back-end data interface 13. If the one-time access has been stored and verified in the backend 10, step iii. of the data release method is carried out so that at least one portion of the personal data is transmitted to the motor vehicle 1. Alternatively, the one-time access is transmitted to the on-board computer 2 and entered by the latter itself via the human-machine interface 3 (preferably in the background, without display for a user 7) or (in a different example) by bypassing the human-machine interface 3.

In step c., the one-time access is optionally entered (by hand) via the human-machine interface 3. For example, the one-time access is a user name and password, wherein the user name and password are shorter and easier than a one-time access from conventional personalization methods (e.g., last name and four-digit PIN). Due to the additional security, this simplification of the one-time access can be carried out by means of the vehicle-specific access authorization information 6. In the case of a plurality of users 7, in one embodiment, a user-specific input is necessary for the release to the backend 10 of only the corresponding user-specific personal data. It should be noted that the arrow associated with step c. also transmits that step a. has taken place and, in an alternative embodiment, solely transmits this information without step iv. and step c.

In step iii. (of the data release method), at least one portion of the personal data is transmitted to a motor vehicle 1 by means of a backend-side data interface 13 (in a sub-step iii.″), wherein the transmission takes place only if the motor vehicle 1 retrieves the personal data with the motor vehicle identity assigned to the personal data (as checked in a previous sub-step iii.′). In this exemplary embodiment, the personal data transmitted (in step b. of the personalization method described above) by means of the backend-side data interface 13 are received by means of the vehicle-side data interface 4.

If the vehicle-specific access authorization information 6 has been acquired by the on-board computer 2, personal data of at least one user 7 assigned to the motor vehicle 1 are retrieved by the on-board computer 2 from the backend 10 by means of the vehicle-side data interface 4 in step b., or vice versa are sent by the backend 10, and are stored in the on-board computer 2, or a portion of the personal data of at least one user 7 are retrieved and stored. The personal data inter alia include the names of the users 7 and the menu language of the infotainment system, for example.

In a subsequent (purely optional) sequence, an authorization is requested to output the stored personal data to a vehicle occupant, who does not have to be the user. This is indicated, for example, in form in a step d. by a human-machine interface 3 to the vehicle occupant. If the vehicle occupant is the user 7, the user is able to enter his/her user name and PIN (or biometric data) into the human-machine interface 3 in a step e. The on-board computer 2 checks the input in a step f. and, if entered correctly, releases the personal data (e.g., shows them on a display and/or, for example, activates personal navigation destinations) in a step g.

The personalization method and data release method significantly simplify the personalization process in a motor vehicle.

### LIST OF REFERENCE SIGNS

1 Motor vehicle
2 On-board computer
3 Human-machine interface
4 Vehicle-side data interface
5 Access security means
6 Access authorization information
7 User
8 Authorized person
9 Access authorization unit
10 Backend
11 Processor
12 Memory device
13 Backend-side data interface
14 Drive wheel
15 Drive unit
16 Access area

What is claimed is:

1. A personalization method for a motor vehicle, wherein the motor vehicle comprises:
an on-board computer;
a human-machine interface;
a vehicle-side data interface; and
an access security means for recognizing physical or electronic vehicle-specific access authorization information,
wherein the personalization method comprises at least the steps of:
a. recognizing, by the on-board computer using the access security means, the physical and/or electronic input of the vehicle-specific access authorization information; and
b. retrieving and storing, by the on-board computer using the vehicle-side data interface, personal data of at least one user assigned to the motor vehicle, wherein step b. is only carried out if in step a., the vehicle-specific access authorization information is recognized.

2. The personalization method according to claim 1, wherein step b. continues to be carried out only if a one-time access has also been entered via the human-machine interface of the motor vehicle in a step c.

3. The personalization method according to claim 2, wherein the one-time access is entered in step c.:
by an authorized person; or
by means of the on-board computer, wherein the on-board computer receives the one-time access by means of the vehicle-side data interface only if the vehicle-specific access information is recognized in step a.

4. The personalization method according to claim 1, wherein recognizing the vehicle-specific access authorization information in step a. is a sufficient condition for carrying out step b.

5. The personalization method according to claim 1, wherein the personal data of the at least one user of the motor vehicle comprises a user-specific security feature, wherein only upon input of the user-specific security feature into the human-machine interface and/or into an access authorization unit, which contains the vehicle-specific access authorization information, at least one of the following privileges is activated:
(i) access to predetermined user information;
(ii) a predetermined function of the motor vehicle; and
(iii) release for external access to the motor vehicle and/or at least one portion of the user information.

6. A data release method for a backend including at least one processor, a memory device, and a backend-side data interface, wherein the data release method comprises at least the steps of:
i. maintaining, by means of the memory device, a register of personal data of a plurality of users and of a plurality of motor vehicle identities;
ii. assigning, by means of the processor, personal data from step i. to a respective motor vehicle identity; and
iii. transmitting, by means of the backend-side data interface upon a retrieval by a motor vehicle with a motor vehicle identity, at least one portion of the associated personal data to the retrieving motor vehicle.

7. The data release method according to claim 6, wherein step iii. is carried out only if a one-time access has been transmitted via the backend-side data interface to the backend in a step iv.

8. The data release method according to claim 6, wherein the presence of the motor vehicle identity and/or the presence of physical and/or electronic vehicle-specific access authorization information is a sufficient condition for carrying out step iii.

9. The data release method of claim 6, wherein the personal data of the at least one user of the motor vehicle comprises a user-specific security feature,
wherein only upon transmission of the user-specific security feature, at least one of the following privileges is transmitted or release for access to at least one of the following privileges is transmitted:
(i) access to predetermined user information;
(ii) a predetermined function of the motor vehicle; and
(iii) release for external access to the motor vehicle and/or at least one portion of the user information.

10. A motor vehicle comprising:
at least one drive wheel, at least one drive unit for driving the motor vehicle via the at least one drive wheel, an on-board computer, a human-machine interface, a vehicle-side data interface and an access security means,
wherein, in communication with a backend, the motor vehicle is configured to:
a. recognize, by the on-board computer using the access security means, a physical and/or electronic input of vehicle-specific access authorization information; and
b. retrieve and store, by the on-board computer using the vehicle-side data interface, personal data of at least one user assigned to the motor vehicle,
wherein step b. is only carried out if in step a., the vehicle-specific access authorization information is recognized.
